(19) United States
(12) Patent Application Publication
(10) Pub. No.: US 2023/0056112 A1
(43) Pub. Date: Feb. 23, 2023

(54) BIRD HUNTING TOOL

(71) Applicant: JACOB SCHMITT, Franklinville, NY (US)

(72) Inventor: JACOB SCHMITT, Franklinville, NY (US)

(21) Appl. No.: 17/892,586

(22) Filed: Aug. 22, 2022

Related U.S. Application Data
(60) Provisional application No. 63/235,842, filed on Aug. 23, 2021.

(51) Int. Cl. A01M 31/00; A01M 31/06

(52) U.S. Cl. CPC A01M 31/002; A01M 31/06

(57) ABSTRACT

This invention is directed to a three-in-one bird hunting tool that includes a dispatcher with a chisel tip, a trigger pin punch, and a bird identification component.

### CROSS-REFERENCE TO RELATED APPLICATIONS

This application claims priority to U.S. Provisional Application having Ser. No. 63/235,842, filed on Aug. 23, 2021, the entire disclosure of which is incorporated herein by reference.

### FIELD OF INVENTION

This invention is directed to a three-in-one bird hunting tool that includes a dispatcher with a chisel tip, a trigger pin punch, and a bird identification component.

### BACKGROUND OF INVENTION

When bird hunting, a hunter may mortally wound a bird without actually killing the bird. This is particularly true when a shotgun is the primary weapon such as when hunting upland game, waterfowl, and other such game. Often, the shotgun is not precise enough to kill the game, but the game fowl is typically struck by a sufficient number of pellets to ensure the death of the animal. Thus, it is often necessary to kill the wounded game humanely after mortally wounding the game. A portable tool for quickly and humanely killing the bird would be beneficial to a hunter.

As mentioned above, shotguns are typically used for bird hunting, but sometimes shotgun shells may get stuck or jammed in the barrel or chamber. In order to resolve this problem, a tool is often needed to remove the stuck shotgun shell.

Another problem that can occur while bird hunting is that the shotgun itself may malfunction or jam. In this case, the pin or pins of the trigger assembly must be removed and then reinstalled. In order to do this, a trigger pin punch is used to pop the pins, which allows the trigger assembly to be removed from the shotgun. It is often necessary to pop the pins and remove the trigger assembly while out in the field. Because bird hunters already have a lot of equipment with them, it would be beneficial if this tool were part of another tool that the bird hunter is already carrying.

When out hunting, it would be beneficial for hunters to have a way to ascertain what type of bird has been caught. Thus, a bird identification component is often a required tool when bird hunting.

Because it isn't convenient to take a variety of tools out into the field while bird hunting, a need exists for a portable combination tool for dispatching fowl humanely, removing stuck shotgun shells, popping the pins out of the shotgun trigger assembly, and identifying what type of bird has been caught.

### SUMMARY OF THE INVENTION

Accordingly, it is the subject of this invention to provide a three-in-one bird hunting tool that includes a dispatcher for humanely killing a wounded bird, a trigger pin punch to pop the trigger assembly out of a shotgun, and a bird identification component.

In one embodiment, a bird hunting tool includes: a main body; a bird identification component along a side of the main body; a trigger punch pin extending from main body; and a dispatcher extending from main body. The bird hunting tool has at least four sides wherein a bottom side of main body is the bird identification component and bird identification component has printed indicia indicating the length of the side and a right and left side of main body are both at obtuse angles with respect to the bird identification component side. The trigger punch pin extends from the top left side of main body and is configured such that it is easy to grip. The dispatcher extends from the top right side of main body and is configured such that it is easy to grip. A top side connecting trigger punch pin and dispatcher. The trigger punch pin is a rectangular shape with a rounded tip at the end distal to the main body and the dispatcher is tapered and includes a chisel tip, which is further tapered to a point.

In another embodiment, a bird hunting tool includes: a main body having at least four sides; a bird identification component along the bottom portion of the main body and having printed indicia indicating length; a trigger punch pin having a rounded rectangular shape extending from the top left of the main body and is configured such that it is easy to grip; and a dispatcher having a tapered shape and extending from the top right of the main body and is configured such that it is easy to grip. The dispatcher further includes a chisel tip, which is further tapered to a point.

In another embodiment, a bird hunting tool includes: a main body; a trigger punch pin having a rounded rectangular shape extending from the main body; and a dispatcher having a tapered shape and extending from the main body. The trigger punch pin extends from the top left side of main body and is configured such that it is easy to grip. The dispatcher extends from the top right side of main body and is configured such that it is easy to grip. The dispatcher further includes a chisel tip, which is further tapered to a point.

### BRIEF DESCRIPTION OF THE DRAWINGS

FIG. 1 depicts a plan view of the three-in-one bird hunting tool.

### DETAILED DESCRIPTION OF THE INVENTION

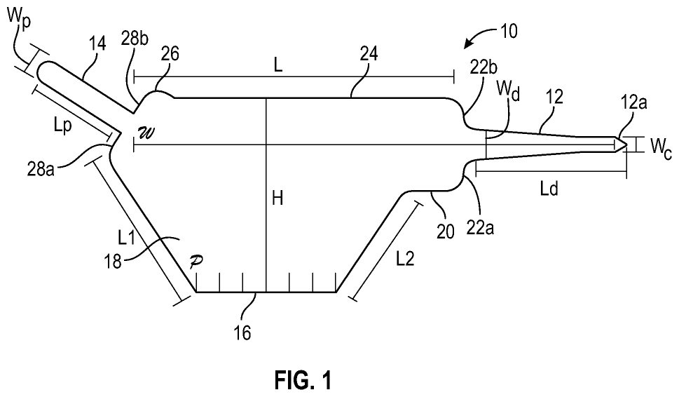

Turning now to FIG. 1, the bird hunting tool 10 includes a dispatcher 12 with a chisel tip 12a, a pin punch 14, and a bird identification component 16. Preferably, the dispatcher 12 is tapered, the chisel tip 12a is further tapered and ends in a point, and the pin punch 14 is a rounded rectangle.

In one embodiment, the dispatcher 12 includes chisel tip 12a capable of humanely killing a crippled bird or water fowl. The chisel tip 12a of dispatcher 12 works by allowing the hunter or user to instantly kill the crippled bird or water fowl by inserting the chisel tip 12a into the side of the head, behind the beak and behind the eye. In another embodiment, the chisel tip 12a doubles as a shotgun shell pry in the event that the shotgun shell gets stuck.

Pin punch 14 can be used to pop the trigger pin of a shotgun, while bird identification component 16 can be used to identify the type of bird killed.

In one embodiment, the top length L of bird hunting tool 10 measures 2.625 inches. The length L_{d} of dispatcher 12 is 0.875 inches and the width W_{d} of dispatcher 12 is 0.144 inches. Dispatcher 12 tapers to width W_{c}. The width W_{c} of the chisel tip 12a is 0.080 inches. The height H of the bird hunting tool at its tallest is 1.848 inches. The length Lₚ of the punch pin is 0.500 inches and the width Wₚ of the punch pin is 0.125 inches.

In another embodiment, the shape of the bird hunting tool 10 is a modified triangle. At one end of length L is trigger pin punch 14 and at the other end is dispatcher 12 with chisel tip 12a. L₁ is between trigger punch pin 14 and bird identification component 16. L₂ is between bird identification component 16 and dispatcher 12. In other embodiments, other tool component arrangements and configurations are envisioned.

In one embodiment, the bird identification component 16 has printed indicia in the form of ruler measurements. In this way, when a bird hunter catches a bird, they can identify whether the bird is male or female and whether the bird is mature or not mature by measuring the bill of the bird.

As depicted in FIG. 1, bird identification component 16 includes letter W and letter P. W area is used for sexing woodcock birds. If the bill is the same length or longer than the measurement line, the bird is female. If the big is shorter shorter than the line, then the bird is male. The P area is for aging rooster pheasants. Measuring from the outside of the leg bone, through the leg bone, to the tip of the spur: if longer than ¾″, the rooster is mature. If shorter than ¾″, the rooster is a juvenile. Preferably, the hash marks are ⅛″ each and the entire length of the bottom of bird identification component 16 is ¾″.

In another embodiment, the bird hunting tool 10 is made of chromium molybdenum steel. Without intending to be bound by theory, it is believed that chromium provides tensile strength and molybdenum provides weather resistance. It is noted that the bird hunting tool 10 may be made of any suitable material including any plastic, wood, any metal or alloy, including steel or stainless steel, or any other material that is strong and weather resistant. The bird hunting tool 10 may be a combination of materials.

In some embodiments, the bird hunting tool 10 can be made as a cast in a mold, or laser cut with engraving added. Alternatively, the bird hunting tool 10 may be 3D printed.

In a preferred embodiment, bird hunting tool 10 includes main body 18, which is shaped roughly like a triangle having trigger punch pin 14 extending from the top left and dispatcher 12 extending from the top right and bird identification component 16 on the bottom. Main body 18 may be thought of as an equilateral triangle. At each location where one would expect the vertex of a triangle, there is a component or tool as discussed above. In the case of the trigger punch pin 14, instead of a vertex, there is a rounded rectangle and has length Lₚ and width Wₚ. The dispatcher 12 includes chisel tip 12a at the end distal to the main body 18. At the portion proximal to the main body 18, dispatcher 12 starts out wider with a width of W_{d} and narrows along length L_{d} to a width of W_{c}. Chisel tip 12a ends in a point for easily and humanely killing a bird if it didn't die after being shot. Finally, bird identification component 16 is located at the bottom of the triangle-like shape. Instead of being shaped like a vortex, bird identification component 16 runs straight across in order to be able to include printed indicia for measuring the length of the killed bird and identifying it.

It is noted that while bird hunting tool 10 has been described as a modified triangle, because of the shape of bird identification tool 16, bird hunting tool 10 is four-sided in preferred embodiments.

In a more preferred embodiment, main body 18 of bird hunting tool 10 is very loosely shaped like a triangle. At the bottom, bird identification component 16 has length P and runs straight across from left to right. At the right hand side, main body 18 angles up at an obtuse angle from bird identification component 16 along a side having length L₂. More than half way up main body 18, the side having length L₂ curves into side 20, which runs parallel with bird identification component 16. From there, side 20 curves upward into side 22a, which is nearly perpendicular to side 20. At dispatcher 12, side 22a curves again along a bottom side have length L_{d}, which extends upward at the right, thereby forming the bottom of chisel tip 12a.

There is a symmetrical top side having length L_{d} that extends towards the left. Both bottom side having length L_{d} and top side having length L_{d} taper such that the left hand side of these sides, W_{d}, is wider than the right hand side W_{c}. Extending toward the left, top side having length L_{d} curves upward into side 22b, which curves into side 24 and is nearly perpendicular to side 24. The curves of the sides creates grip for the user.

Side 24 is parallel to bird identification component 16. Side 24 continues extending to the left into arch 26, which is convex to side 24 and extends into side 28b, which is parallel to side having length L₂. Side 28b extends at a right angle up to trigger punch pin 14 having two parallel sides having lengths Lₚ. The top side having length Lₚ ends at a curved portion having width Wₚ, which extends to bottom side having length Lₚ. From there, bottom side having length Lₚ extends to side 28a at a right angle. Side 28a is also parallel to side having length L₂. Extending downward and to the left, side 28a curves into side having length L_{1.}. As with the curves near dispatcher 12, the curves of the sides near pin punch 14 creates grip for the user. Side having length L_{1.} extends to the right back to bird identification component 16. Similar to side having length L₂, side having length L₁ is at an obtuse angle with bird identification component 16.

In a simplified embodiment, bird hunting tool 10 includes main body 18 having a trigger pin punch 14 to the top left of main body 18, a dispatcher 12 at the top right of main body 18 and a bird identification component 16 along the bottom side of main body 18.

It is noted that while the above embodiments all describe a bird hunting tool 10 having a trigger pin punch 14 on the left and a dispatcher 12 on the right, these components could be configured opposite of this. That is, trigger pin punch 14 may be located on the right of bird hunting tool 10 and dispatcher 12 may be located on the left. Any suitable arrangement of the components is envisaged.

### EXAMPLES

### Example 1

If the bird is a woodcock, the hunter can measure the bill of the woodcock. If the bill measures 2.61″ or more, then the hunter knows the bird is female. If it is less than 2.61″, then the hunter knows the bird is male. Conveniently, the W indicia on the bird hunting tool W measures 2.61″

### Example 2

For rooster pheasants, the bird can be measured to determine maturity. If the spurs of the rooster pheasant are less than ¾″, then the bird is a juvenile, but if it the spurs are greater than ¾″, the bird is a mature adult.

It will be appreciated by those skilled in the art that while the bird hunting tool has been described in detail herein, the invention is not necessarily so limited and other examples, embodiments, uses, modifications, and departures from the embodiments, examples, uses, and modifications may be made without departing from the process and all such embodiments are intended to be within the scope and spirit of the appended claims.

What is claimed is:

1. A bird hunting tool comprising:
a main body;
a bird identification component along a side of the main body;
a trigger punch pin extending from main body; and
a dispatcher extending from main body.

2. The bird hunting tool of claim 1 wherein the main body has at least four sides.

3. The bird hunting tool of claim 2 wherein a bottom side of main body is the bird identification component and bird identification component has printed indicia indicating the length of the side.

4. The bird hunting tool of claim 3 wherein a right and left side of main body are both at obtuse angles with respect to the bird identification component side.

5. The bird hunting tool of claim 4 wherein the trigger punch pin extends from the top left side of main body and is configured such that it is easy to grip.

6. The bird hunting tool of claim 5 wherein the dispatcher extends from the top right side of main body and is configured such that it is easy to grip.

7. The bird hunting tool of claim 6 wherein there is a top side connecting trigger punch pin and dispatcher.

8. The bird hunting tool of claim 7 wherein the trigger punch pin is a rectangular shape with a rounded tip at the end distal to the main body.

9. The bird hunting tool of claim 8 wherein the dispatcher is tapered.

10. The bird hunting tool of claim 9 wherein the dispatcher further includes a chisel tip, which is further tapered to a point.

11. A bird hunting tool comprising:
a main body having at least four sides;
a bird identification component along the bottom portion of the main body and having printed indicia indicating length;
a trigger punch pin having a rounded rectangular shape extending from the top left of the main body and is configured such that it is easy to grip; and
a dispatcher having a tapered shape and extending from the top right of the main body and is configured such that it is easy to grip.

12. The bird hunting tool of claim 11 wherein the dispatcher further includes a chisel tip, which is further tapered to a point.

13. A bird hunting tool comprising:
a main body;
a trigger punch pin having a rounded rectangular shape extending from the main body; and
a dispatcher having a tapered shape and extending from the main body.

14. The bird hunting tool of claim 13 wherein the trigger punch pin extends from the top left side of main body and is configured such that it is easy to grip.

15. The bird hunting tool of claim 13 wherein the dispatcher extends from the top right side of main body and is configured such that it is easy to grip.

16. The bird hunting tool of claim 15 wherein the dispatcher further includes a chisel tip, which is further tapered to a point.
